(19) United States
(12) Patent Application Publication
(10) Pub. No.: US 2013/0216169 A1
(43) Pub. Date: Aug. 22, 2013

(54) MULTI-LAYER PLAIN BEARING HAVING AN ANTI-FRETTING LAYER

(71) Applicant: Jakob Zidar, Altmuenster (AT)

(72) Inventor: Jakob Zidar, Altmuenster (AT)

(73) Assignee: MIBA GLEITLAGER GMBH, Laakirchen (AT)

(21) Appl. No.: 13/640,891

(22) PCT Filed: Apr. 14, 2011
(86) PCT No.: PCT/AT11/00185

§ 371 Date: Nov. 5, 2012

(30) Foreign Application Priority Data
Apr. 15, 2010 (AT) A 602/2010

(51) Int. Cl. F16C 33/12

(52) U.S. Cl. CPC F16C 33/125
USPC 384/276

(57) ABSTRACT

The invention relates to a multi-layer plain bearing (1) that has a front side (4) that can face the element to be supported and a rear side (6) opposite the front side, comprising a supporting layer (2), a sliding layer (3) arranged on the front side (4) and an anti-fretting layer (5) arranged on the rear side (6), wherein the anti-fretting layer (5) is made of a copper-based alloy having copper mixed-crystal grains. The copper-based alloy of the anti-fretting layer (5) is formed by a binary alloy having an alloying element from the group comprising aluminum, zinc, indium, silicon, germanium, and antimony or by an at least ternary alloy having one alloying element from the group comprising aluminum, zinc, indium, silicon, germanium, tin, and antimony and at least one further element from the group and/or the further group comprising nickel, cobalt, iron, manganese, bismuth, lead, silver and phosphorus, possibly with unavoidable impurities originating from production, wherein the total fraction of the alloying elements is at least 1 wt. % and at most 30 wt. %.

The invention relates to a multi-layered plain bearing with a front side facing the element to be supported and a rear side opposite the latter, comprising a support layer, an anti-frictional layer arranged on the front side and an anti-fretting layer arranged on the rear side, wherein the anti-fretting layer consists of a copper-based alloy with copper mixed crystal grains.

The rear coating of a plain bearing with an anti-fretting layer is already known from the prior art. By means of this coating the frictional welding or frictional corrosion and thereby the “seizing” of the plain bearing is avoided in the bearing housing as a result of unwanted relative movements of the components. Frictional corrosion often leads to frictional fatigue fractures. The frictional corrosion is also determined by the pairing of materials. Hard materials or components with hard surfaces layers are more prone to wear by frictional corrosion than soft materials which are more prone to seizing. In the latter case the relative movement is prevented and damage is also caused.

In order to address this problem many different materials have already been described in the prior art for the production of an anti-fretting layer. Thus for example AT 506 641 A1 of the same applicant describes a silver alloy for this use. From AT 399 544 B, also of the same applicant, a corrosion support layer made from an Sn-alloy is known. Ni, Cr or Co alloys for anti-fretting layers are known from GB 2315301 A1, According to WO 02/48563 A1a tin bronze is used as the anti-fretting layer. A Cu—Sn-alloy deposited galvanically as an anti-fretting layer on steel with a proportion of tin of between 10% and 15% is known from GB 556,248 A and GB 554,355 A.

The problem addressed by the invention is to provide an improved multi-layered plain bearing, in particular an improved anti-fretting layer based on copper.

This objective is achieved by the aforementioned multi-layered plain bearing, in which the copper-based alloy of the anti-fretting layer contains an alloy element from the group comprising or consisting of aluminum, zinc, indium, silicon, germanium, antimony or an alloy element from the group comprising or consisting of aluminum, zinc, indium, silicon, germanium, tin, antimony and at least one further element from this group and/or a second group comprising or consisting of nickel, cobalt, iron, manganese, bismuth, lead, silver, phosphorus and contains unavoidable impurities originating from production, wherein the total amount of these alloy elements is at least 1 wt. % and a maximum of 30 wt. %.

In the search for an anti-fretting layer with improved properties the Applicant has examined, in addition to the already mentioned silver alloy layers, copper-based alloys among others and has established surprisingly that the copper-based alloys mentioned above have much better wearing properties and/or a much greater fatigue strength, and in each case improved protection from damage caused by fretting than others, whereby the bearings provided therewith can be used in particular for highly stressed bearings. The reason for this is the addition of an alloy element from the group comprising or consisting of aluminum, zinc, indium, silicon, germanium, selenium, antimony to form a binary alloy or an alloy element from the group comprising or consisting of aluminum, zinc, indium, silicon, germanium, tin, antimony and at least one further element from said group and/or a second group comprising or consisting of nickel, cobalt, iron, manganese, bismuth, lead, silver, phosphorus for the formation of an at least ternary alloy system.

In particular, the strength of the anti-fretting layer is improved by silicon.

The corrosion resistance of the anti-fretting layer is improved by means of zinc, nickel and cobalt. The cold-forming ability of the anti-fretting layer is also improved by zinc.

To improve the anti-frictional property of the anti-fretting layer in addition to the copper mixed crystal phase there can be an anti-frictional soft phase in the matrix, which in particular is formed by lead, bismuth or at least one solid lubricant such as MoS₂, graphite, WS₂ etc.

Germanium, indium, tin, bismuth, lead and antimony improve the adaptability and/or the corrosion resistance of the anti-fretting layer on the housing mounting the plain bearing.

By means of aluminum, zinc, indium, silicon, germanium, selenium and antimony the tendency of the copper material to weld with the steel is also reduced. The applicant suspects that the mutual solubility, i.e. of the housing material in the coating material and vice versa, reduces the transfer of material, improves the corrosion resistance and mechanical resistance to wear and fatigue by the formation of a substitution mixed crystal and that by means of the alloy partners the formation of thin, adhesive oxide layers and/or reaction layers separating the surfaces from one another is facilitated by oil additives.

By means of combinations of these elements the properties of the coating can be adjusted specifically or tailored to the respective application.

It was observed that below a specific content the effect is too low, above a specific content and in particular above a total content of 30 wt. % large amounts of hard, brittle intermetallic phases are formed which have a negative effect on the anti-fretting layer.

Thus for example by the addition of 1 wt. % to 25 wt. % Zn or 1 wt. % to 20 wt. % indium a Cu—Sn or Cu—Ge alloy is much less sensitive to corrosion, in particular from sulfur-containing oil additives.

A Cu—Al alloy is significantly more resistance to wear by the addition of 0.2 wt. % to 15 wt. % antimony, as a proportion of the alloy elements is deposited as a finely dispersed AlSb hard phase.

By alloying one or more elements from the group manganese, iron, nickel, cobalt the mechanical strength of the coating and its corrosion resistance is significantly increased. In particular, by means of nickel the shapability is also improved. Unfortunately, by means of these elements the tendency to weld with the housing material is increased. This effect has been observed in particular at contents of above 5 wt. %, in particular above 10 wt. %.

In combination with phosphorus Me3P and Me2P phases are formed, where Me represents a metal from the above group manganese, iron, nickel, cobalt. Said hard phases distributed finely in the matrix improve the anti-fretting properties significantly. As the respective metals are bound in said phases, their negative influence on the tendency to weld with the housing material is reduced and is mostly overcome by the positive influence of the hard phases, whereby the strength is mostly maintained by the finely dispersed deposits.

By alloying one or more elements from the group lead, bismuth and silver or by the addition of solid lubricants such as graphite, MoS₂, WS₂ an additional phase is introduced into the structure which has particularly good anti-frictional properties. In this way damage by fretting can be reduced further or damage under extreme operating conditions can be reduced (comparable with the emergency running properties of a bearing metal).

Lead, bismuth and solid lubricants are particularly soft materials which potentially could weaken the loading ability of the coating, therefore their content needs to have an upper limit.

Silver is heavily attacked by many, in particular sulfur-containing, oil additives. This unwanted effect is particularly marked at contents of over 20 wt. %.

Details of the preferred ranges in the following embodiment variants should be considered while taking the above information into account.

According to one embodiment variant the tin content is between 5 wt. % and 25 wt. %, preferably between 8 wt. % and 19 wt. %, in particular between 10 wt. % and 16 wt. %. In this way the hardness of the anti-fretting layer is increased, whereby on the one hand the tendency to “seizing” is reduced and on the other hand the wearing resistance is also increased further. Above 25 wt. % intermetallic phases are formed which are very brittle, whereby the wearing resistance falls even further. Below 5 wt. % however, small improvements can be observed which in themselves do not provide the desired improvements.

In particular, the aforementioned effects relating to better wearing properties, greater fatigue strength and/or better protection from fretting damage occur when at least one of the following conditions is met:
the amount of aluminum in the copper-based alloy is between 2 wt. % and 12 wt. %, preferably between 4 wt. % and 8 wt. %,
the amount of silicon in the copper-based alloy is between 2 wt. % and 10 wt. %, preferably between 3 wt. % and 5 wt. %,
the amount of germanium in the copper-based alloy is between 3 wt. % and 15 wt. %, preferably between 4 wt. % and 10 wt. %,
the amount of indium in the copper-based alloy is between 0.2 wt. % and 20 wt. %, preferably between 1 wt. % and 5 wt. %, in particular between 2 wt. % and 4 wt. %,
the amount of zinc in the copper-based alloy is between 0.5 wt. % and 25 wt. %, preferably between 1 wt. % and 5 wt. %. Above 15 wt. % the anti-fretting layer is too “brittle”. Below 0.5 wt. % no substantial improvement in the properties of the copper alloy could be observed.
the amount of manganese in the copper-based alloy is between 0.2 wt. % and 5 wt. %, preferably between 0.2 wt. % and 2 wt. %, in particular between 0.3 wt. % and 1 wt. %,
the amount of iron in the copper-based alloy is between 0.2 wt. % and 5 wt. %, preferably between 0.2 wt. % and 2 wt. %, in particular between 0.3 wt. % and 1 wt. %,
the amount of nickel in the copper-based alloy is between 0.2 wt. % and 8 wt. %, preferably between 0.5 wt. % and 5 wt. %, in particular between 1 wt. % and 3 wt. %,
the amount of cobalt in the copper-based alloy is between 0.2 wt. % and 8 wt. %, preferably between 0.5 wt. % and 5 wt. %, in particular between 1 wt. % and 3 wt. %,
the total amount of manganese, iron, nickel and cobalt is a maximum of 10 wt. %, preferably a maximum of 6 wt. %,
the amount of bismuth in the copper-based alloy is between 1 wt. % and 25 wt. %, preferably between 2 wt. % and 15 wt. %, in particular between 5 wt. % and 10 wt. %,
the amount of lead in the copper-based alloy is between 1 wt. % and 25 wt. %, preferably between 2 wt. % and 15 wt. %, in particular between 5 wt. % and 10 wt. %,
the amount of silver in the copper-based alloy is between 1 wt. % and 20 wt. %, preferably between 2 wt. % and 10 wt. %,
the amount of antimony in the copper-based alloy is between 0.2 wt. % and 15 wt. %, preferably between 0.2 wt. % and 10 wt. %, in particular between 1 wt. % and 5 wt. %,
the amount of phosphorus is between 0.01 wt. % and 3 wt. %, preferably between 0.05 wt. % and 0.3 wt. % or with a total alloy amount of Mn, Fe, Ni and Co of above 0.6 wt. % preferably between 2% and 50%, even more preferably between 10% and 30% of this value of 0.05 wt. % and 0.3 wt. %,
the amount of rare earth metals, chromium, zirconium, titanium and beryllium is a total of between 0.001 wt. % and 0.5 wt. %, preferably between 0.01 wt. % and 0.2 wt. %. Said elements can be alloyed to at least two main alloy elements for grain refinement or hardening.
the amount of selenium is a maximum of 0.1 wt. %, preferably between 0.0001 wt. % and 0.01 wt. %. Selenium acts in cyanide copper electrolytes as a brightener, also the micro-dispersion and micro-leveling can be improved. However, higher contents of selenium do not embrittle the layer.

Instead of selenium sulfur or tellurium can also be used.

It is also possible that the anti-fretting layer has a content of one or more of the elements silicon, germanium, indium, zinc, nickel, cobalt, bismuth, lead and antimony, wherein their total proportion is between 0.2 wt. % and 20 wt. %. Thus a further adjustment of the anti-fretting layer to highly-stressed bearings is possible.

According to one embodiment variant the anti-fretting layer has a layer thickness of between 2 μm and 100 μm, preferably between 3 μm and 30 μm, in particular between 4 μm and 15 μm. By keeping the lower limit of 2 μm for the layer thickness the anti-fretting layer forms a cohesive layer even after the wear of the rough peaks. At layer thicknesses of over 100 μm a worsening in the adhesion of the anti-fretting layer to the base caused by tensions at the interface was observed.

The anti-fretting layer preferably has a Vickers micro-hardness for a test load of 3 Pond of between HV 200 and HV 500, preferably between HV 230 and HV 400, in particular between HV 250 and HV 350, whereby the abrasion caused by micromovements of the plain bearing can be reduced in the housing and thus the frictional corrosion of the anti-fretting layer can be reduced further. Above 500 HV the plastic deformability is mostly so low that localized forces lead to the formation of tears and breaks in the layer. Below 200 HV the wearing resistance is not achieved to the desired extent.

Preferably, the copper mixed crystal grains in the anti-fretting layer have a grain size of more than 5 nm, preferably more than 10 nm, in particular more than 50 nm. In this way the crystalline nature of the copper-based alloy is more marked and as a result also the properties dependent on the orientation described above are more prevalent.

According to one embodiment variant the anti-fretting layer is preferably essentially free of intermetallic phases and appears in the XRD measurement as mixed crystals with copper crystal lattice, whereby according to a preferred embodiment variant the latter consists of copper mixed crystals with a lattice constant of between 0.3630 nm and 0.3750 nm. In this way the formation of the preferred alignment of the copper mixed crystal grains in the layer of copper-based alloy is supported and at least not impaired, so that the anti-fretting layer has a more homogenous property profile.

According to one embodiment variant the anti-fretting layer has a layer thickness of at least 50%, in particular at least 150%, and a maximum of 1,000%, preferably a maximum of 300%, of the roughness Rz of the support layer or an intermediate layer possibly arranged between the support layer and the anti-fretting layer. In this way a “leveling effect” of the layer beneath the anti-fretting layer is achieved, whereby at the same time by means of the existing roughness an improved adhesion can be achieved between said layer and the anti-fretting layer. In particular, in this way abrasion is avoided more effectively which may be caused by profile peaks of the roughness profile of the layer underneath the anti-fretting layer.

To increase the adaptability of the multi-layered plain bearing to a surface of the housing mounting the latter it is possible for the anti-fretting layer to have a coating which is softer than the anti-fretting layer. Preferably, said coating is made from a material which is selected from a group comprising tin, lead, bismuth, polymer-based anti-frictional paints.

For a better understanding of the invention the latter is explained in more detail with reference to the following FIGURE.

In a much simplified representation:

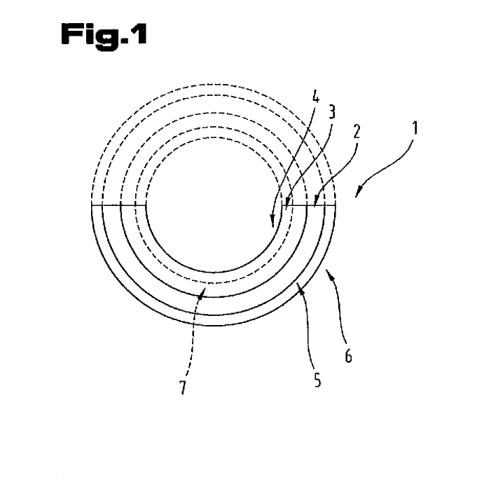

FIG. 1 shows a multi-layered plain bearing in the form of a plain bearing half shell in side view;

First of all, it should be noted that details relating to position used in the description, such as e.g. top, bottom, side etc. relate to the currently described and represented FIGURE and in case of a change in position should be adjusted to the new position. Furthermore, also individual features or combinations of features from the various exemplary embodiments shown and described can represent in themselves independent or inventive solutions.

FIG. 1 shows a multi-layered plain bearing 1 in the form of a plain bearing half shell. A three-layered variant of the multi-layered plain bearing 1 is shown, consisting of a support layer 2, an anti-frictional layer 3, which is arranged on a front side 4 of the multi-layered plain bearing 2, which faces the component to be mounted, and an anti-fretting layer 5, which is arranged on a rear side 6 of the multi-layered plain bearing 1 and on the support layer 2. If necessary a bearing metal layer 7 can be arranged between the anti-frictional layer 4 and the support layer 2, as indicated by dashed lines in FIG. 1.

The main structure of such multi-layered plain bearings 1, as used e.g. in internal combustion engines, is known from the prior art and further explanations are therefore unnecessary here. It should be mentioned however that additional layers can be provided, for example an adhesive layer and/or a diffusion barrier layer can be provided between the anti-frictional layer 4 and the bearing metal layer 3 and/or between the anti-fretting layer 5 and the support layer 2, likewise an adhesive layer can be provided between the bearing metal layer 3 and the support layer 2.

Within the scope of the invention the multi-layered plain bearing 1 can also be configured differently, for example as a bearing bush, as indicated by dashed lines in FIG. 1. Also embodiments such as run-on rings, axially running sliding shoes or the like are possible.

Furthermore, it is also possible within the scope of the invention that the bearing metal layer 3 is omitted, so that the anti-frictional layer 4 can be applied onto the support layer 2 either directly or with the intermediate arrangement of an adhesive and/or a diffusion barrier layer.

The support metal layer 2 is preferably made of steel but can also be made from a material which gives the multi-layered plain bearing 1 the necessary structural strength. Such materials are known from the prior art.

For the bearing metal layer 3 or the anti-frictional layer 4 and the intermediate layers the alloys or materials known from the relevant prior art can be used and reference is made thereto. According to the invention the anti-fretting layer 5 consists of a copper-based alloy, which in addition to Cu contains an alloy element from the group comprising or consisting of aluminum, zinc, indium, silicon, germanium, antimony or an alloy element from the group comprising or consisting of aluminum, zinc, indium, silicon, germanium, tin, antimony and at least one further element from said group and/or a second group comprising or consisting of nickel, cobalt, iron, manganese, bismuth, lead, silver, phosphorus as well as unavoidable impurities originating from production, wherein the total proportion of these alloy elements is at least 1 wt. % and a maximum of 30 wt. %, and wherein in the cooper alloy there are copper mixed crystal grains formed from copper and the elements.

The amount of aluminum in the copper-based alloy can be between 2 wt. % and 12 wt. %, preferably between 4 wt. % and 8 wt. %.

The tin content can be between 5 wt. % and 25 wt. %, preferably between 8 wt. % and 19 wt. %, in particular between 10 wt. % and 16 wt. %.

The zinc content can be between 0.5 wt. % and 25 wt. %, preferably between 1 wt. % and 5 wt. %.

The amount of manganese can be between 0.2 wt. % and 5 wt. %, preferably between 0.2 wt. % and 2 wt. %, in particular between 0.3 and 1 wt. %.

The amount of iron can be between 0.2 wt. % and 5 wt. %, preferably between 0.2 wt. % and 2 wt. %, in particular between 0.3 wt. % and 1 wt. %.

The content of silicon can be between 2 wt. % and 10 wt. %, preferably between 3 wt. % and 5 wt. %.

The content of germanium can be between 3 wt. % and 15 wt. %, preferably between 4 wt. % and 10 wt. %.

The content of indium can be between 0.2 wt. % and 20 wt. %, preferably between 1 wt. % and 5 wt. %, in particular between 2 wt. % and 4 wt. %.

The content of nickel can be between 0.2 wt. % and 8 wt. %, preferably between 0.5 wt. % and wt. %, in particular between 1 wt. % and 3 wt. %.

The content of cobalt can be between 0.2 wt. % and 8 wt. %, preferably between 0.5 wt. % and 5 wt. %, in particular between 1 wt. % and 3 wt. %.

The content of bismuth can be between 1 wt. % and 25 wt. %, preferably between 2 wt. % and 15 wt. %, in particular between 5 wt. % and 10 wt. %.

The content of lead can be between 1 wt. % and 25 wt. %, preferably between 2 wt. % and 15 wt. %, in particular between 5 wt. % and 10 wt. %.

The amount of silver can be between 1 wt. % and 20 wt. %, preferably between 2 wt. % and 10 wt. %.

The content of antimony can be between 0.2 wt. % and 15 wt. %, preferably between 0.2 wt. % and 10 wt. %, in particular between 1 wt. % and 5 wt. %.

The amount of phosphorus can be between 0.01 wt. % and 3 wt. %, preferably between 0.05 wt. % and 0.3 wt. % or with a total alloy amount of Fe, Ni and Co of over 0.2 wt. % preferably between 10% and 200%, even more preferably between 50% and 150%, of this value.

The amount of rare earth metals, chromium, zirconium, titanium and beryllium can be in total between 0.001 wt. % and 0.5 wt. %, preferably between 0.01 wt. % and 0.2 wt. %.

The amount of selenium can be a maximum of 0.1 wt. %, in particular between 0.0001 wt. % and 0.01 wt. %.

Instead of selenium sulfur or tellurium can also be used.

Preferably, the total content of one or more the elements silicon, germanium, indium, zinc, nickel, cobalt, bismuth, lead and antimony can be between 0.2 wt. % and 20 wt. %.

Said copper-based alloys are preferably deposited galvanically on the rear side 6 of the respective substrate, for example the support layer 2. The electrolyte for this can contain cyanide or are preferably cyanide-free. Preferred parameters for the deposition and preferred bath compositions are given in the following examples.

### EXAMPLE 1

### Cyanide-Containing Electrolyte for Depositing a Cu—Sn—Zn Alloy

| | |
|---|---|
| copper (I) | 0.25 mol/l-0.35 mol/l |
| tin (IV) | 0.10 mol/l-0.20 mol/l |
| zinc | 0.05 mol/l-0.20 mol/l |
| free cyanide | 0.30 mol/l-0.45 mol/l |
| free alkalinity | 0.20 mol/l-0.30 mol/l |
| tartrate | 0 mol/l-0.20 mol/l |
| additive | 0.5 g/l-5 g/l |
| temperature | 55° C.-65° C. |
| current density | 1 A/dm²-4 A/dm² |

### EXAMPLE 2

### Cyanide-Containing Electrolyte for Depositing a Cu—Ge—Zn Alloy

| | |
|---|---|
| copper (I) | 0.25 mol/l-0.35 mol/l |
| germanium | 0.05 mol/l-0.30 mol/l |
| zinc | 0.05 mol/l-0.20 mol/l |
| free cyanide | 0.30 mol/l-0.45 mol/l |
| free alkalinity | 0.20 mol/l-1.0 mol/l |
| citrate | 0 mol/l-0.20 mol/l |
| additive | 0.5 g/l-5 g/l |
| temperature | 55° C.-65° C. |
| current density | 1 A/dm²-4 A/dm² |

### EXAMPLE 3

### Cyanide-Free Electrolyte Based on Methane Sulfonic Acid for the Deposition of a Cu—Sn—Bi alloy

| | |
|---|---|
| copper (II) | 0.25 mol/l-0.35 mol/l |
| tin (II) | 0.10 mol/l-0.20 mol/l |
| bismuth | 0.05 mol/l-0.2 mol/l |
| free acid | 0.8 mol/l-2 mol/l |
| additive | 5 g/l-50 g/l |
| temperature | 20° C.-30° C. |
| current density | 0.5 A/dm²-3 A/dm² |

### EXAMPLE 4

### Cyanide-Free Electrolyte Based on Tetrafluoroboric Acid for the Deposition of a Cu—Sn—Sb—Pb Alloy

| | |
|---|---|
| copper (II) | 0.25 mol/l-0.35 mol/l |
| tin (II) | 0.10 mol/l-0.20 mol/l |
| antimony (III) | 0.02 mol/l-0.10 mol/l |
| lead (II) | 0.05 mol/l-0.5 mol/l |
| free acid | 0.8 mol/l-2 mol/l |
| additive | 5 g/l-50 g/l |
| temperature | 20° C.-30° C. |
| current density | 0.5 A/dm²-3 A/dm² |

### EXAMPLE 5

### Cyanide-Free Electrolyte Based on Pyrophosphate or Phosphonate for the Deposition of a Cu—Sn—In Alloy

| | |
|---|---|
| copper (II) | 0.10 mol/l-0.40 mol/l |
| tin (II) | 0.05 mol/l-0.50 mol/l |
| indium | 0.05 mol/l-0.50 mol/l |
| pH value | 8-10 |
| additive | 0.5 g/l-50 g/l |
| temperature | 40° C.-80° C. |
| current density | 0.5 A/dm²-5 A/dm² |

In the preferred embodiment of the electrolyte the latter also contains organic compounds in addition to the salts for the metals to be deposited. In particular, in the case of cyanide electrolytes the latter are polycarboxylic acid salts such as citrate or tartrate, in the case of the non-cyanide acid electrolytes the latter are naphthol or naphthol derivatives or thio compounds. In this way the focus of the invention can be maintained over a wider range of bath parameters.

The following salts can be used for depositing the metals:

Copper can be used in the form of copper(II)tetrafluoroborate, copper(II)methane sulfonate, copper(II)sulfate, copper(II)pyrophosphate, copper(I)cyanide, copper salts of hydroxy and/or aminophosphonic acids. In general, the concentration of copper in the electrolyte can be between 0.05 mol/l and 1 mol/l.

Tin can be used in the form of tin(II)tetrafluoroborate, tin(II)methane sulfonate, tin(II)sulfate, tin(II)pyrophosphate, sodium stannate, potassium stannate, tin(II)salts of hydroxy and/or amino phosphonic acids. In general, the concentration of tin in the electrolyte can be up to 0.5 mol/l.

Zinc can be used in the form of zinc(II)tetrafluoroborate, zinc(II)methane sulfonate, zinc(II)sulfate, zinc(II)pyrophosphate, zinc oxide, zinc cyanide, zinc(II)salts of hydroxy- and/or amino phosphonic acids. In general the concentration of zinc in the electrolyte can be up to 0.5 mol/l.

Silicon can be added as a powder or for example in the form of silicon carbide to the electrolyte in order to form dispersion layers.

Germanium can be used in the form of germanium oxide or sodium or potassium germanate. In general, the concentration of germanium in the electrolyte can be up to 0.5 mol/l.

Indium can be used in the form of indium oxide, indium cyanide, indium sulfate, indium fluoroborate, indium methane sulfonate. In general the concentration of indium in the electrolyte can be up to 0.5 mol/l.

Nickel can be used in the form of nickel(II)tetrafluoroborate, nickel(II)methane sulfonate, nickel(II)sulfate, ammonium nickel sulfate, nickel(II)chloride, nickel(II)pyrophosphate, nickel(II)oxide. In general the concentration of nickel in the electrolyte can be up to 1 mol/l.

Manganese, cobalt and iron can be used in the same form and concentration as nickel.

Bismuth can be used in the form of bismuth trifluoride, bismuth(III)methane sulfonate, bismuth(III)sulfate, bismuth(III)pyrophosphate, bismuth oxide, sodium or potassium bismutate. In general the concentration of bismuth in the electrolyte can be up to 0.5 mol/l.

Lead can be used in the form of lead(II)tetrafluoroborate, lead(II)methane sulfonate, lead(II)pyrophosphate, lead acetate, lead(II)oxide, sodium or potassium plumbate. In general the concentration of lead in the electrolyte can be up to 0.3 mol/l.

Antimony can be used in the form of antimony(III)tetrafluoroborate, antimony trifluoride, antimony(III)oxide, potassium antimony tartrate. In general the concentration of antimony in the electrolyte can be up to 0.2 mol/l.

Silver can be used in the form of cyanide, alkali silver cyanide, silver methane sulfonate, silver nitrate. In general the concentration of antimony in the electrolyte can be up to 0.5 mol/l.

Phosphorus can be used in the form of phosphoric acid, alkali phosphite, alkali hypophosphite. In general the concentration can be up to 2 mol/L.

Selenium can be used in the form of selenium dioxide, alkali selenate or alkali selenite. In general the concentration of selenium in the electrolyte can be between 0.05 mmol/l and 5 mmol/l.

Possible stabilizers or supporting electrolytes, conducting salts or complexing agents are: alkali cyanide, alkali hydroxide, tetrafluoroboric acid, hydrofluoric acid, methane sulfonic acid, tartaric acid and the alkali and ammonium salts thereof, citric acid and the alkali and ammonium salts thereof, ammonium and alkali pyrophosphates, phosphonic acid the alkali and ammonium salts thereof, 2.2-ethylene dithiodiethanol, hydantoin and derivatives thereof, succinimide and derivatives thereof, phenol and cresol sulfonic acids, in a total concentration of between 0.1 mol/l and 2 mol/l.

Possible oxidation inhibitors in cyanide-free electrolytes are: resorcin, hydroquinone, pyrocatechol, pyrogallol, formaldehyde, methanol, in a total concentration of between 0.03 mol/l and 0.3 mol/l.

Possible additives are: phenolphthalein, thio compounds and derivatives thereof, thiourea and the derivatives thereof, alpha or beta naphtol and their ethoxylates, alpha and beta naphthol sulfonic acid and their ethoxylates, o-toluidin, hydroxyl chinolin, lignosulfonate, butindiol, in a total concentration of between 0.0005 mol/l and 0.05 mol/l, preferably 0.002 mol/l and 0.02 mol/l and gelatin, glue, non-ionic and cationic surfactants, amino compounds, for example C8-C20-amidopropylamine and derivatives thereof, polyethylene glycol and its functional derivatives, peptone, glycine, in a total concentration of between 0 g/l-50 g/l.

Also mixtures of the aforementioned components of the electrolytes can be used, i.e. e.g. at least two salts of a or the respective metal and/or at least two stabilizers and/or at least two oxidation inhibitors and/or at least two additives.

It should be noted that for safety reasons cyanide-containing electrolytes can only be produced from alkali salts or premixtures.

The alloy elements can be added in the form of the aforementioned, soluble compounds or complexes to a corresponding electrolyte and are deposited therewith from the latter. Similarly it is possible to form an alloy by diffusing the elements into the layer or co-depositing particles suspended in the electrolyte.

In addition to galvanic deposition other methods of producing the copper-based alloy or the anti-fretting layer are possible. For example the copper-based alloy can be cast and a strip thereof can be rolled onto the substrate. However, also direct casting on the substrate is possible, whereby the additional step of forming a strip can be omitted. Said methods are known in principle from the prior art so that reference is made thereto in this regard.

However, PVD methods such as sputtering, vapor depositing, CVD methods, ion implantation processes, flame spray and plasma spray methods, casting methods, sintering methods or plating methods can also be used for producing the anti-fretting layer 5 or for its modification, e.g. by means of an ion implantation process, etc.

The depositing of the respective anti-fretting layer 5 can be performed on an already preformed multi-layered plain bearing 1, i.e. e.g. on a plain bearing shell. Similarly, it is possible within the scope of the invention that the anti-fretting layer 5 is deposited on a plane substrate strip, for example a steel strip, and the mechanical shaping into a finished multi-layered plain bearing 1, for example by pressing etc., is only performed in a subsequent production step.

In this way anti-fretting layers 5 of the following compositions given in Table 1 were produced. The data on the composition are given in wt. %. The remainder to 100 wt. % is formed by copper in each case.

TABLE 1
Compositions of anti-fretting layers 5

| | Al | Si | Ge | Sn | In | Zn | Mn | Fe | Ni | Co | Bi | Pb | Ag | Sb | P | Other |
|---|---|---|---|---|---|---|---|---|---|---|---|---|---|---|---|---|
| 1 | 2 | | 10 | | | | | 0.3 | | | | | | | 0.2 | |
| 2 | 4 | | | | | | 1 | | 1 | | | | | | | Cr: 0.1 |
| 3 | 6 | | | | | | | | | | | 8 | | | | |
| 4 | 8 | | | | | | | | | | | | 5 | | | |
| 5 | 12 | | | | | 2 | | | | | | | | | | |
| 6 | 5 | | | | | | | | | | | | | 2 | | |
| 7 | 7 | 1.5 | | | | | | | | | | | | | 0.1 | |
| 8 | | 2 | | | | | | | 2 | | | | | | | |
| 9 | | 5 | | | 2 | | | | | | | | | | | |
| 10 | | | 4 | | | 5 | | | | | | | | | | |
| 11 | | | 10 | | | | | | | | | | 1 | | | |
| 12 | | | 15 | | 1 | | | | 5 | | | | | | | La; 0.1 |
| 13 | | | | 10 | 3 | | 1 | | | | | | | | | |
| 14 | | | | 15 | 2 | | | | | | | | | | | |
| 15 | | | | 20 | | 3 | | | | | | | | | | |
| 16 | | | | 10 | | 5 | | | | 0.5 | | | | | | |
| 17 | | | | 13 | | 1 | | | | | | | | | | Zr: 0.05 |
| 18 | | | | 10 | | 1 | | | | | | 10 | | | | |
| 19 | | | | 10 | | | | | | | 15 | | | | | |
| 20 | | | | 5 | | 5 | | | | | | 15 | | | | |
| 21 | | | | 5 | | | | | | | | | | 2 | | |
| 22 | | | 2 | 10 | | | | | | | | | | | | |
| 23 | | | | 17 | | 2 | | | | | 10 | | | | | |
| 24 | | | | 12 | | | | | | | | 9 | | | | |
| 25 | | 1 | 2 | 5 | | 5 | | | | | | | | | | |
| 26 | | | | 11 | 3 | | | | | | | | | | | |
| 27 | | | | 24 | | | | | | 5 | | | | | | |
| 28 | 3 | | | | | 15 | 2 | 2 | 1 | | | | | | | |
| 29 | | | | | | | 2 | 2 | | | | | 1.2 | | 0.8 | |
| 30 | | 10 | | | 10 | | | | | | | | | | | |
| 31 | | | | | 15 | | 5 | | | | | | | | | |
| 32 | | | | | 20 | | | 4 | | | | | | | | |
| 33 | | | | | | 25 | | | | 5 | | | | | | MoS2: 2 |
| 34 | | | | | 8 | | | | | | 20 | | | | | |
| 35 | | | | | 2 | | | | | | | 25 | | 1 | | |
| 36 | | | 8 | | | 1 | | | | | | | 20 | | | |

For reasons of comparison CuSn alloys according to GB 2315301 A1 were produced on steel (Examples 37 to 40) and according to WO 02/48563 A1 (Example 41) on a Ti connecting rod. The details on the compositions in Table 2 are given in wt. %.

TABLE 2
CuSn alloys according to the prior art

| No. | Sn | Cu |
|---|---|---|
| 37 | 11 | Rem. |
| 38 | 8.4 | Rem. |
| 39 | 15 | Rem. |
| 40 | 13 | Rem. |
| 41 | 6 | Rem. |

It was shown in the test that the at least ternary CuSn alloys according to the invention had much better properties than the CuSn alloys according to the prior art. Here a cylindrical stamp (showing the housing bore) was pressed with a pressure of 10 MPa onto a plate coated with corresponding materials (showing the rear bearing). The contact area was oiled. The stamp and plate were exposed to a relative movement of 0.1 mm amplitude at a frequency of 10 Hz. All of the trials were carried out at 120° C. over 1,000,000 relative movements. After the completion of the trial the contact points on the plate and stamp were examined. In all of the samples oil carbons formed on the contact surfaces. The level of damage was graded between 1—no damage and 10—heavy fretting. The results are summarized in Table 3.

TABLE 3
Test results for Examples 1 to 35

| No. | Result | No. | Result | No. | Result |
|---|---|---|---|---|---|
| 1 | 3 | 2 | 5 | 3 | 4 |
| 4 | 2 | 5 | 3 | 6 | 5 |
| 7 | 3 | 8 | 6 | 9 | 4 |
| 10 | 4 | 11 | 4 | 12 | 5 |
| 13 | 3 | 14 | 3 | 15 | 5 |
| 16 | 3 | 17 | 4 | 18 | 3 |
| 19 | 3 | 20 | 3 | 21 | 4 |
| 22 | 5 | 23 | 2 | 24 | 2 |
| 25 | 4 | 26 | 4 | 27 | 4 |
| 28 | 3 | 29 | 3 | 30 | 2 |
| 31 | 5 | 32 | 5 | 33 | 4 |
| 34 | 3 | 35 | 3 | 36 | 2 |
| 37 | 10 | 38 | 8 | 39 | 9 |
| 40 | 7 | 41 | 6 | | |

The tests were performed on different stamp materials (e.g. steel cast iron, aluminum, titanium) and surfaces (ground, shot-peened, etc.) and also with plates without coatings and with different surfaces, the above results were confirmed. The parameters of the test such as pressure, amplitude, temperature and lubricating oil were varied. The results were correlated with the results from engine trials and the test results on parts from the field.

It has been shown clearly that all of the anti-fretting layers 5 according to the invention and also all of the tested layers according to the prior art reduced the fretting attack compared to uncoated materials. This result is not surprising, therefore the individual results of this are not shown in detail here. The evaluation scale was set accordingly so that it is possible to distinguish more effectively between good and less good coatings, whereby it should also be stressed that a coated test part with an evaluation of 9 or even 10 (heavy fretting) was generally much less damaged than an uncoated test pair for example steel plate against steel plate or titanium plate against steel stamp.

It is all the more surprising that with the anti-fretting layers 5 of the invention compared to the layers of the prior art a further a clear reduction of the damage by fretting can be achieved.

Binary alloys for the anti-fretting layer 5 in the above amount ranges have an evaluation of between 4 and 6.

According to a preferred embodiment variant of the anti-fretting layer 5 the latter has a layer thickness of between 2 μm and 100 μm, preferably between 3 μm and 30 μm, in particular between 4 μm and 15 μm, as already explained above.

As mentioned above the anti-fretting layer 5 has a layer thickness of at least 50%, in particular at least 150%, and a maximum of 1,000%, preferably a maximum of 300%, of the roughness Rz of the support layer or an intermediate layer possibly arranged between the support layer and the anti-fretting layer.

Tests were also performed for this. The results are summarized in Table 4.

TABLE 4
Examination of the influence of the layer thickness on the quality
of the anti-fretting layer 5 (surface ground, Rz = 5 μm)

| | Layer thickness [μm] | Evaluation |
|---|---|---|
| CuSn13Zn3 | 1 | 10 |
| CuSn13Zn3 | 4 | 5 |
| CuSn13Zn3 | 12 | 3 |
| CuSn13Zn3 | 25 | 4 |
| CuSn13Zn3 | 100 | 5 |
| CuSn13Zn3 | 500 | 9 |

Preferably, for the above-mentioned reasons the anti-fretting layer 5 has a Vickers microhardness at a test load of 3 Pond of between HV 200 and HV 500, preferably between HV 230 and HV 400, in particular between HV 250 and HV 350.

Evaluations of X-ray diffraction investigations have shown that there is an improvement in the properties of the anti-fretting layer 5, if the copper mixed crystal grains have a grain size of more than 5 nm, preferably more than 10 nm, in particular more than 50 nm.

XRD measurements of the anti-fretting layer 5 have also shown that copper-based alloys have better properties when the latter are essentially free of intermetallic phases and appear as a mixed crystal with a copper crystal lattice, whereby it is particularly preferable if said copper-based alloys are made of copper mixed crystals with a lattice constant of between 0.3630 nm and 0.3750 nm.

For the aforementioned reasons the anti-fretting layer 5 can also have a coating which is softer than the anti-fretting layer 5, wherein the coating is preferably made from a material which is selected from a group comprising tin, lead, silver, bismuth, polymer-based antifrictional paints. In principle, all antifrictional paints can be used that are known in the field of plain bearings. Preferably however, an antifrictional paint is used which in a dry state consists of 40 wt. % to 45 wt. % MoS2, 20 wt. % to 25 wt. % graphite and 30 wt. % to 40 wt. % polyamide imide, whereby if necessary hard particles such as e.g. oxides, nitrides or carbides, can be included in the antifrictional paint in a proportion of a total of a maximum 20 wt. %, which replace a proportion of the solid lubricants.

As a point of formality it should be noted that for a better understanding of the structure of the multi-layered plain bearing 1 the latter or its components have not been represented true to scale in part and/or have been enlarged and/or reduced in size.

### LIST OF REFERENCE NUMERALS

1 multi-layered plain bearing
2 support layer
3 anti-frictional layer
4 front side
5 anti-fretting layer
6 rear side
7 bearing metal layer

1. A multi-layered plain bearing (1) with a front side (4) facing the element to be supported and rear side (6) opposite thereto, comprising a support layer (2), an anti-frictional layer (3) arranged on the front side (4) and an anti-fretting layer (5) arranged on the rear side (6), the anti-fretting layer (5) being made from a copper-based alloy with copper mixed crystal grains, wherein the copper-based alloy of the anti-fretting layer (5) is formed by a binary alloy with an alloy element from the group aluminum, zinc, indium, silicon, germanium, antimony or by an at least ternary alloy with an alloy element from the group aluminum, zinc, indium, silicon, germanium, tin, antimony and at least one further element from said group and/or the additional group nickel, cobalt, iron, manganese, bismuth, lead, silver, phosphorus, if necessary with unavoidable impurities originating from production, wherein the total proportion of these alloy elements is at least 1 wt. % and a maximum of 30 wt. %.

2. The multi-layered plain bearing (1) as claimed in claim 1, wherein the proportion of tin in the copper-based alloy is between 5 wt. % and 25 wt. %, preferably between 8 wt. % and 19 wt. %, in particular between 10 wt. % and 16 wt. %.

3. The multi-layered plain bearing (1) as claimed in claim 1, wherein the proportion of aluminum in the copper-based alloy is between 2 wt. % and 12 wt. %, preferably between 4 wt. % and 8 wt. %.

4. The multi-layered plain bearing (1) as claimed in claim 1, wherein the proportion of silicon in the copper-based alloy is between 2 wt. % and 10 wt. %, preferably between 3 wt. % and 5 wt. %.

5. The multi-layered plain bearing (1) as claimed in claim 1, wherein the proportion of germanium in the copper-based alloy is between 3 wt. % and 15 wt. %, preferably between 4 wt. % and 10 wt. %.

6. The multi-layered plain bearing (1) as claimed in claim 1, wherein the proportion of indium in the copper-based alloy is between 0.2 wt. % and 20 wt. %, preferably between 1 wt. % and 5 wt. %, in particular between 2 wt. % and 4 wt. %.

7. The multi-layered plain bearing (1) as claimed in claim 1, wherein the proportion of zinc in the copper-based alloy is between 0.5 wt. % and 25 wt. %, preferably between 1 wt. % and 5 wt. %.

8. The multi-layered plain bearing (1) as claimed in claim 1, wherein the proportion of manganese in the copper-based alloy is between 0.2 wt. % and 5 wt. %, preferably between 0.2 wt. % and 2 wt. %, in particular between 0.3 wt. % and 1 wt. %.

9. The multi-layered plain bearing (1) as claimed in claim 1, wherein the proportion of iron in the copper-based alloy is between 0.2 wt. % and 5 wt. %, preferably between 0.2 wt. % and 2 wt. %, in particular between 0.3 wt. % and 1 wt. %.

10. The multi-layered plain bearing (1) as claimed in claim 1, wherein the proportion of nickel in the copper-based alloy is between 0.2 wt. % and 8 wt. %, preferably between 0.5 wt. % and 5 wt. %, in particular between 1 wt. % and 3 wt. %.

11. The multi-layered plain bearing (1) as claimed in claim 1, wherein the proportion of cobalt in the copper-based alloy is between 0.2 wt. % and 8 wt. %, preferably between 0.5 wt. % and 5 wt. %, in particular between 1 wt. % and 3 wt. %.

12. The multi-layered plain bearing (1) as claimed in claim 1, wherein the proportion of bismuth in the copper-based alloy is between 1 wt. % and 25 wt. %, preferably between 2 wt. % and 15 wt. %, in particular between 5 wt. % and 10 wt. %.

13. The multi-layered plain bearing (1) as claimed in claim 1, wherein the proportion of lead in the copper-based alloy is between 1 wt. % and 25 wt. %, preferably between 2 wt. % and 15 wt. %, in particular between 5 wt. % and 10 wt. %.

14. The multi-layered plain bearing (1) as claimed in claim 1, wherein the proportion of silver in the copper-based alloy is between 1 wt. % and 20 wt. %, preferably between 2 wt. % and 10 wt. %.

15. The multi-layered plain bearing (1) as claimed in claim 1, wherein the proportion of antimony in the copper-based alloy is between 0.2 wt. % and 15 wt. %, preferably between 0.2 wt. % and 10 wt. %, in particular between 1 wt. % and 5 wt. %.

16. The multi-layered plain bearing (1) as claimed in claim 1, wherein the proportion of phosphorus is between 0.01 wt. % and 3 wt. %, preferably between 0.05 wt. % and 0.3 wt. % or with a total alloy amount of Mn, Fe, Ni and Co of over 0.6 wt. % preferably between 2% and 50%, even more preferably between 10% and 30% of this value of 0.05 wt. % and 0.3 wt. %.

17. The multi-layered plain bearing (1) as claimed in claim 1, wherein the alloy contains selenium, wherein the proportion of selenium is a maximum of 0.1 wt. %, preferably between 0.0001 wt. % and 0.01 wt. %.

18. The multi-layered plain bearing (1) as claimed in claim 1, wherein the total amount of manganese, iron, nickel and cobalt is a maximum of 10 wt. %, preferably a maximum of 6 wt. %.

19. The multi-layered plain bearing (1) as claimed in claim 1, wherein the copper-based alloy contains at least one further element from a third group comprising or consisting of rare earth metals, chromium, zirconium, titanium and beryllium in an amount of a total of between 0.001 wt. % and 0.5 wt. %, preferably between 0.01 wt. % and 0.2 wt. %.

20. The multi-layered plain bearing (1) as claimed in claim 1, wherein the total content of one or more of the elements silicon, germanium, indium, zinc, nickel, cobalt, bismuth, lead and antimony in the copper-based alloy is between 0.2 wt. % and 20 wt. %.

21. The multi-layered plain bearing (1) as claimed in claim 1, wherein the anti-fretting layer (5) has a layer thickness of between 2 μm and 100 μm, preferably between 3 μm and 30 μm, in particular between 4 μm and 15 μm.

22. The multi-layered plain bearing (1) as claimed in claim 1, wherein the anti-fretting layer (5) has a Vickers microhardness at a test load of 3 Pond of between HV 200 and HV 500, preferably between HV 230 and HV 400, in particular between HV 250 and HV 350.

23. The multi-layered plain bearing (1) as claimed in claim 1, wherein the copper mixed crystal grains have a grain size of more than 5 nm, preferably of more than 10 nm, in particular of more than 50 nm.

24. The multi-layered plain bearing (1) as claimed in claim 1, wherein the anti-fretting layer (5) is substantially free of intermetallic phases and appears in the XRD measurement as a mixed crystal with copper crystal lattice.

25. The multi-layered plain bearing (1) as claimed in claim 24, wherein the anti-fretting layer (5) is made of copper mixed crystals with a lattice constant of between 0.3630 nm and 0.3750 nm.

26. The multi-layered plain bearing (1) as claimed in claim 1, wherein the anti-fretting layer (5) has a layer thickness of at least 50%, in particular at least 150%, and a maximum of 1,000%, preferably a maximum of 300%, of the roughness Rz of the support layer (5) or an intermediate layer arranged possibly between the support layer (2) and the anti-fretting layer (5).

27. The multi-layered plain bearing (1) as claimed in claim 1, wherein the anti-fretting layer (5) has a coating which is softer than the anti-fretting layer (5).

28. The multi-layered plain bearing (1) as claimed in claim 27, wherein the coating is made from a material which is selected from a group comprising tin, lead, bismuth, polymer-based anti-frictional paints.
